(19) United States
(12) Patent Application Publication
(10) Pub. No.: US 2022/0288567 A1
(43) Pub. Date: Sep. 15, 2022

(54) LAYERED MAGNESIUM MANGANESE COMPOSITE MATERIAL FOR COPPER ION ADSORPTION, PREPARATION METHOD THEREFOR AND APPLICATION THEREOF

(71) Applicant: SOUTH CHINA UNIVERSITY OF TECHNOLOGY, Guangzhou (CN)

(72) Inventors: Pingxiao WU, Guangzhou (CN); Meiqing CHEN, Guangzhou (CN); Zhi DANG, Guangzhou (CN); Feike PEI, Guangzhou (CN); Lu LIN, Guangzhou (CN)

(73) Assignee: SOUTH CHINA UNIVERSITY OF TECHNOLOGY, Guangzhou (CN)

(21) Appl. No.: 17/827,821

(22) Filed: May 30, 2022

Related U.S. Application Data
(63) Continuation of application No. PCT/CN2020/124570, filed on Oct. 29, 2020.

(30) Foreign Application Priority Data
Nov. 30, 2019 (CN) 201911208949.X

(51) Int. Cl. B01J 23/72; B01J 27/236; B01J 37/03; B01J 37/06; B01J 37/00; B01J 37/30; B01J 37/08; C02F 1/28

(52) U.S. Cl. CPC B01J 23/72; B01J 27/236; B01J 37/031; B01J 37/06; B01J 37/0036; B01J 37/30; B01J 37/088; C02F 1/288; C02F 1/281; C02F 2101/20

(57) ABSTRACT

Disclosed are a layered magnesium manganese composite material for copper ion adsorption, a preparation method therefor and an application thereof. The preparation method comprises: (1) dissolving a soluble magnesium salt and a soluble manganese salt in water to obtain a compound solution of the magnesium salt and the manganese salt; (2) dissolving a soluble carbonate and a soluble hydroxide in water to obtain a compound solution of the carbonate and the hydroxide; (3) dropwise adding the compound solution of the magnesium salt and the manganese salt into the compound solution obtained in step (2), stirring a mixed solution and allowing the mixed solution to age, and subjecting an obtained precipitate to centrifugation, washing, drying, grinding and sieving to obtain the layered magnesium manganese composite material for copper ion adsorption. The composite material provided by the present invention is excellent in ability to fix Cu²⁺, and features high absorption efficiency, high adsorption speed and stability. The composite material not only can fix Cu²⁺ efficiently, but also has important environmental significance in treating antibiotics in the environment and achieving in-situ remediation of compound pollution of heavy metals and organic matters.

### CROSS-REFERENCE TO RELATED APPLICATION

This application is a continuation of international application of PCT application serial no. PCT/CN2020/124570 filed on Oct. 29, 2020, which claims the priority benefit of China application no. 201911208949.X, filed on Nov. 30, 2019. The entirety of each of the above-mentioned patent applications is hereby incorporated by reference herein and made a part of this specification.

### BACKGROUND OF THE INVENTION

### 1. Technical Field

The present invention belongs to the technical field of adsorption materials, and particularly relates to a layered magnesium manganese composite material for copper ion adsorption, a preparation method therefor and an application thereof.

### 2. Background of Related Art

Copper pollution of water body will affect the aquatic ecosystem and copper will enter the food chain of human to harm human bodies. Copper and its compounds have been included in a “blacklist” of precedence-controlled pollutants of water body in China. Adsorption method is a widely and effectively applied method to remove copper pollution of water bodies at present, but common adsorbents have small adsorption capacity to copper. Layered double hydroxides (LDHs) have excellent adsorption capacity to copper due to a large number of active sites such as hydroxyl on the surfaces, and interlayer anions of the LDH such as carbonates also can remove copper efficiently and fixedly. The LDH further features simple preparation, low cost and environmental-friendliness. Besides, secondary pollution caused by waste adsorbents in the adsorption method is the major reason that imposes restrictions on promotion of the adsorption method. On a basis of secondary pollution caused by waste adsorbents in the adsorption method and higher economical value of copper, copper in the wastewater can be recycled while the copper-containing wastewater is treated, so that waste is turned into wealth. The prominent advantages of copper series catalysts in the fields of photocatalysis and catalytic oxidization are brought into full play, and secondary resource utilization of copper is realized.

### SUMMARY OF THE INVENTION

In order to overcome disadvantages and shortcomings in the prior art, the present invention is intended to provide a layered magnesium manganese composite material for copper ion adsorption, a preparation method therefor and an application thereof. The layered magnesium manganese composite material has excellent fixing performance and stability to copper. After the layered magnesium manganese composite material adsorbs the heavy metal copper, its waste adsorbent is used for catalytically degrading organic matter pollution, thereby realizing resource reutilization of copper.

The purpose of the present invention is at least realized by one of the technical solutions as follows:

A method for preparing a layered magnesium manganese composite material for copper ion adsorption provided by the present invention includes the following steps:

(1) dissolving a soluble magnesium salt and a soluble manganese salt in water to obtain a compound solution of the magnesium salt and the manganese salt;

(2) dissolving a soluble carbonate and a soluble hydroxide in water to obtain a compound solution of the carbonate and the hydroxide;

(3) dropwise adding the compound solution of the magnesium salt and the manganese salt obtained in step (1) into the compound solution of the carbonate and the hydroxide obtained in step (2), performing even stirring to obtain a mixed solution, allowing the mixed solution to age, centrifugalizing the mixed solution to take a precipitate, and subjecting the precipitate to washing, drying, grinding and sieving to obtain the layered magnesium manganese composite material for copper ion adsorption.

Further, the magnesium salt in step (1) is magnesium chloride, magnesium nitrate or magnesium sulfate; the manganese salt in step (1) is manganese chloride, manganese nitrate or manganese sulfate; and in the compound solution of the magnesium salt and the manganese salt obtained in step (1), a concentration of the magnesium salt is 0.03-0.09 mol/L and a concentration of the manganese salt is 0.015-0.045 mol/L.

Preferably, the magnesium salt in step (1) is magnesium chloride.

Preferably, the manganese salt in step (1) is manganese chloride.

Further, the carbonate in step (2) is sodium carbonate or potassium carbonate; the hydroxide in step (2) is sodium hydroxide or potassium hydroxide; and in the compound solution of the carbonate and the hydroxide obtained in step (2), a concentration of the carbonate is 0.0025-0.2 mol/L and a concentration of the hydroxide is 0.005-0.4 mol/L.

Preferably, the carbonate in step (2) is sodium carbonate.

Preferably, the hydroxide in step (2) is sodium hydroxide.

Further, in the mixed solution obtained in step (3), a molar ratio of the magnesium salt to the manganese slat to the carbonate to the hydroxide is (5-60):(2.5-30):(1-15):(2-30).

Preferably, in the mixed solution in step (3), a molar ratio of the magnesium salt to the manganese slat to the carbonate to the hydroxide is (10-20):(5-10):(4-8):(8-16).

Further, in step (3), a rate of dropwise adding the compound solution of the magnesium salt and the manganese salt into the compound solution of the carbonate and the hydroxide is 0.1-5 mL/min, and a stirring time is 0.5-4 h.

Further, an aging time in step (3) is 12-36 h, a drying mode includes freeze drying with a drying time of 12-36 h, and a slot size for sieving is 100-500 meshes.

The present invention provides the layered magnesium manganese composite material for copper ion adsorption prepared by the above-mentioned method.

An application of the layered magnesium manganese composite material for copper ion adsorption in catalyzing degradation of an antibiotic provided by the present invention includes the following steps:

adsorbing copper ions by the layered magnesium manganese composite material for copper ion adsorption to obtain an adsorbed layered magnesium manganese composite material; heating the adsorbed layered magnesium manganese composite material for calcining treatment; cooling the adsorbed layered magnesium manganese composite material to room temperature to obtain CuO—MgMn-LDO; and adding the CuO—MgMn-LDO into an antibiotic solution to catalyze degradation of the antibiotic.

Further, in the application of the layered magnesium manganese composite material for copper ion adsorption in catalyzing degradation of the antibiotic, a temperature of calcining treatment is 250-350° C., and a time of calcining treatment is 1-5 h.

Further, in the application of the layered magnesium manganese composite material for copper ion adsorption in catalyzing degradation of the antibiotic, a pH value of the antibiotic solution is 3.0-9.0.

Preferably, the antibiotic is sulfamethoxazole (SMX), tetracycline (TC), Ciprofloxacin (CIP) and sulfadiazine (SMZ), and more preferably, the antibiotic sulfamethoxazole (SMX).

The preparation method and the obtained products of the present invention have the following advantages and beneficial effects:

(1) The layered magnesium manganese composite material for copper ion adsorption provided by the present invention is a layered magnesium manganese composite material prepared based on high fixing performance of Layered double hydroxides on heavy metal copper. The composite material has excellent fixing performance in removing Cu and features high fixing speed and stability;

(2) The layered magnesium manganese composite material for copper ion adsorption provided by the present invention can fix Cu efficiently, and sulfonamide antibiotics can be catalytically degraded by calcining the material fixed with heavy metals, so that resource recycling of Cu is realized, in-situ remediation of compound pollution of heavy metals and organic matters, the prominent advantages of copper series catalysts in the fields of photocatalysis and catalytic oxidization are brought into full play, and it has important environmental significance;

(3) According to the preparation method provided by the present invention, elements contained in the magnesium salt and the manganese salt are natural components which feature low price, wide source, no environmental pollution and the like;

(4) The preparation method provided by the present invention features simplicity, mild reaction condition, low energy consumption, high productivity and wide application prospect.

### BRIEF DESCRIPTION OF DRAWINGS

FIG. 1 is a curve graph of a fixing quantity of MgMn-LDH prepared in an embodiment 1 at different Cu initial concentrations.

FIG. 2 is an SEM diagram of MgMn-LDH (a), Cu—MgMn-LDH (b), MgMn-LDO-300 (c) and CuO—MgMn-LDO-300 (d) prepared in an embodiment 1.

FIG. 3 is an XRD diagram of MgMn-LDH, Cu—MgMn-LDH, MgMn-LDO-300 and CuO—MgMn-LDO-300 prepared in an embodiment 1.

FIG. 4 is an influence diagram of performance of CuO—MgMn-LDO-300 that catalyzes PS to degrade sulfamethoxazole at different calcining temperatures in an embodiment 2.

FIG. 5 is a comparison diagram of MgMn-LDO-300 and CuO—MgMn-LDO-300 on sulfamethoxazole removal performance and degree of mineralization.

FIG. 6 is an influence diagram showing that CuO—MgMn-LDO-300 degrades and removes sulfamethoxazole at different pH values.

FIG. 7 is a dissolving out diagram showing that CuO—MgMn-LDO-300 degrades Cu and Mn of a sulfamethoxazole system at different pH values.

FIG. 8 is a recycling performance diagram showing that CuO—MgMn-LDO-300 activates PMS to degrade sulfamethoxazole.

### DETAILED DESCRIPTION OF EMBODIMENTS

Further description of the present invention in detail will be made below in combination with specific embodiments and drawings, but implementation modes of the present invention are not limited thereto.

### Embodiment 1

A method for preparing a layered magnesium manganese composite material for treating copper pollution of waste water provided by the present invention includes the following steps:

(1) 0.06 mol of magnesium chloride hexahydrate and 0.03 mol manganese chloride tetrahydrate (a ratio of Mg to Mn is 2) were accurately weighed and dissolved with 1000 mL deionized water to obtain a compound solution of a magnesium salt and a manganese salt;

(2) 0.005 mol of sodium carbonate and 0.01 mol sodium hydroxide were dissolved with 1000 mL deionized water to obtain a compound solution of a carbonate and a hydroxide;

(3) The compound solution of the magnesium salt and the manganese salt were slowly dropped into the compound solution in step (2) at a dropping speed of 2 mL/min, and the mixed solutions were evenly stirred for 2 h;

(4) The mixed solution was subjected to aging for 24 h, then a supernate was removed after being centrifugalized at 4000 r/min for 5 min, a precipitate was washed with deionized water for several times, the precipitate was subjected to freeze drying for 24 h, and the precipitate was ground and sieved by a 200-mesh sieve to obtain layered magnesium manganese composite material powder, i.e., the layered magnesium manganese composite material for copper ion adsorption (MgMn-LDH).

Test of an application result of the obtained layered magnesium manganese composite material in treating heavy metal copper pollution: several 10 mg of layered magnesium manganese composite materials were accurately weighted and respectively placed in 50 ml centrifuge tubes, 50 mL prepared Cu²⁺ solutions at different Cu²⁺ initial concentrations (Cu²⁺ initial concentrations were respectively 60 mg L⁻¹, 100 mg L⁻¹, 120 mg L⁻¹, 200 mg L⁻¹, 250 mg L⁻¹, 350 mg L⁻¹ and 500 mg L⁻¹) were respectively removed to the centrifuge tubes, the solutions subjected to intensive mixing were placed on a water bath oscillator at 30±1° C. to be vibrated for 24 h, supernates were taken and filtered by a 0.45 μm filter membrane, and the concentrations of residual Cu²⁺ in the solutions were measured by an atomic absorption spectrophotometer.

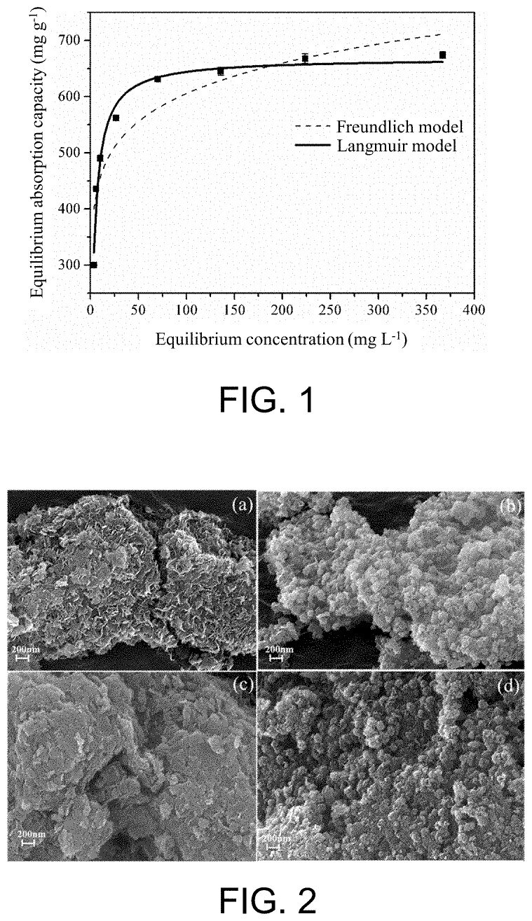

A test result is as shown in Table 1. It can be seen from FIG. 1 that a Freundlich adsorption equation can better describe the adsorption characteristic of the layered magnesium manganese composite material to Cu²⁺, which shows that adsorption of Cu²⁺ by the layered magnesium manganese composite material is polymolecular layer adsorption. It can be known from Langmuir fitting that the maximum adsorption capacity of the layered magnesium manganese composite material to Cu²⁺ can reach up to 668 mg g⁻¹, showing that the layered magnesium manganese composite material has an excellent fixing effect to Cu²⁺.

Cu—MgMn-LDHs formed by MgMn-LDH and MgMn-LDH adsorbing copper obtained in step (4) were respectively calcined in a Muffle furnace at 300° C. for 3 h, and were naturally cooled to room temperature to obtain MgMn-LDO-300 and CuO—MgMn-LDO-300. C in CuO—MgMn-LDO-C represents a calcining temperature.

Morphologies and structures of the layered magnesium manganese composite material after and before being calcined were represented by a scanning electron microscope (SEM, ZEISS Merlin). Results were shown in a-d in FIG. 2. A typical lamellar morphology of MgMn-LDH (shown in a in FIG. 2) collapsed in the calcining process (shown in c in FIG. 2). The morphology of Cu—MgMn-LDH (b in FIG. 2) was that small particles were evenly attached to MgMn-LDH, which is because of CuCO3 and Cu(OH)₂ formed in the Cu²⁺ fixing process. The particles on the CuO—MgMn-LDO-300 became small and compact (d in FIG. 2), indicating that calcining enhanced their stability.

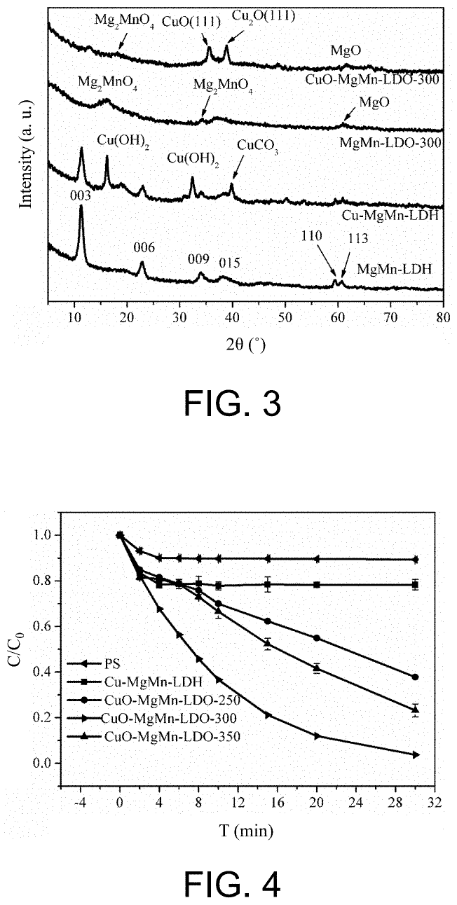

In order to further verify the deduction, the above-mentioned materials were subjected to XRD analysis, XRD diagrams of MgMn-LDH, Cu—MgMn-LDH, MgMn-LDO-300 and CuO—MgMn-LDO-300 being shown in FIG. 3. MgMn-LDH showed broad peaks at 11.5°, 22.9°, 33.8°, 37.9°, 59.5° and 60.8° corresponding to the characteristic peaks (003), (006), (009), (015), (110) and (113) of the Layered double hydroxide (LDH). With respect to Cu—MgMn-LDH, two new peaks were observed at 16.4° and 32.3°, which could be assigned to (020) and (002) of Cu(OH)2. The other new peak was located at 39.8° corresponding to (111) of CuCO3. This verified that Cu(OH)₂ and CuCO3 were formed in the process in which MgMn-LDH fixed Cu²⁺. MgMn-LDO-300 had three peaks where 2θ were 18.2° and 35.7°, which were the characteristic peaks of Mg2MnO4. Besides, the peak emerged when 20 was 62.4° showed that there was MgO. It was to be noted that CuO and (111) Cu2O peaks in CuO (111) in CuO—MgMn-LDO-300 sheltered peaks of Mg2MnO4 and MgO, which was consistent with the observation results of SEM and TEM.

### Embodiment 2

An application of a layered magnesium manganese composite material in catalytic degradation of sulfamethoxazole includes the following steps:

(1) 0.06 mol of magnesium chloride hexahydrate and 0.03 mol manganese chloride tetrahydrate (a ratio of Mg to Mn is 2) were accurately weighed and dissolved with 1000 mL deionized water to obtain a compound solution of a magnesium salt and a manganese salt;

(2) 0.005 mol of sodium carbonate and 0.01 mol sodium hydroxide were dissolved with 1000 mL deionized water to obtain a compound solution of a carbonate and a hydroxide;

(3) The compound solution of the magnesium salt and the manganese salt were slowly dropped into the compound solution in step (2) at a dropping speed of 2 mL/min, and the mixed solutions were evenly stirred for 2 h;

(4) The mixed solution was subjected to aging for 24 h, then a supernate was removed after being centrifugalized at 4000 r/min for 5 min, a precipitate was washed with deionized water for several times, the precipitate was subjected to freeze drying for 24 h, and the precipitate was ground and sieved by a 200-mesh sieve to obtain layered magnesium manganese composite material powder, i.e., the layered magnesium manganese composite material for copper ion adsorption (MgMn-LDH);

(5) Several parts of 10 mg of layered magnesium manganese composite materials were accurately weighted and respectively placed in 50 ml centrifuge tubes, 50 mL prepared 250 mg L⁻¹ Cu solutions were respectively removed to the centrifuge tubes, the solutions subjected to intensive mixing were placed on a water bath oscillator at 30+/−1° C. to be vibrated for 24 h, materials with fixed Cu were recovered, supernates were removed after the materials were centrifugalized at 4000 r/min for 5 min, the materials were washed with deionized water for several times, and the materials were dried at 60° C. for 24 h, ground and sieved by a 200-mesh sieve to obtain the layered magnesium manganese composite materials (Cu—MgMn-LDH) which had absorbed Cu²⁺;

(6) several parts of Cu—MgMn-LDH were respectively calcined in a Muffle furnace at different temperatures for 3 h and were then naturally cooled to room temperature (the temperature was set to be 250° C., 300° C., 350° C. and 400° C.) so as to obtain CuO—MgMn-LDO-250, CuO—MgMn-LDO-300, CuO—MgMn-LDO-350 and CuO—MgMn-LDO-400, wherein C in CuO—MgMn-LDO-C represents a calcining temperature; and

(7) A sample prepared in step (6) was used for catalyzing an antibiotic to investigate influence on performance of CuO—MgMn-LDO that catalyzes persulfate (PS) to degrade sulfamethoxazole.

Six parts of 50 mL of SMX (0.02 mM) were taken and numbered. No materials were added into No. 1, 10 mg of Cu—MgMn-LDH was added into No. 2, 10 mg of MgMn-LDO-250 was added into No. 3, 10 mg of CuO—MgMn-LDO-300 was added into No. 4, 10 mg of CuO—MgMn-LDO-350 was added into No. 5, and 10 mg of CuO—MgMn-LDO-400 was added into No. 6. Magnetic stirring was performed for 30 min to realize an adsorption-desorption equilibrium between the materials and SMX, and 1.0 mM of PS was added to activate the reaction; 1 mL of solution was taken at predetermined time intervals (2 min, 4 min, 6 min, 8 min, 10 min, 15 min, 20 min, 30 min and 60 min) and was filtered by the 0.45 μm filter membrane, and 0.1 mL of Na₂S₂O₄ (0.04 mM) quenching agent was added. The concentrations of SMX were detected by High Performance Liquid Chromatography (HPLC, Aglient 1260). As shown in FIG. 4, the calcining temperature could affect the catalytic performance of the materials by affecting the structures and stability of the materials. Compared with Cu—MgMn-LDH, the catalytic activities of CuO—MgMn-LDO-250 and CuO—MgMn-LDO-350, particularly CuO—MgMn-LDO-300, were remarkably enhanced. However, the catalytic activity of CuO—MgMn-LDO-400 was similar to that of Cu—MgMn-LDH, indicating that a too high calcining temperature resulted in material hardening and thereby affected the catalytic activity.

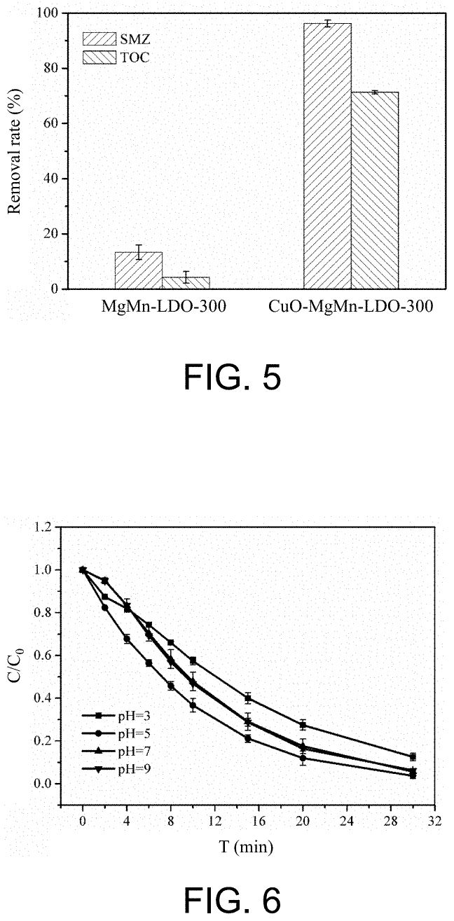

Compared with CuO-MgMnLDO-300 to sulfamethoxazole on removal performance and degree of mineralization, MgMn-LDH and Cu—MgMn-LDH were calcined in the Muffle furnace at 300° C. for 3 h and were then naturally cooled to room temperature to obtain MgMn-LDO-300 and CuO—MgMn-LDO-300. Two parts of 50 mL of SMX (0.02 mM) were taken and numbered. 10 mg of MgMn-LDO-300 was added into No. 1, and 10 mg of CuO—MgMn-LDO-300 was added into No. 2. Magnetic stirring was performed for 30 min to realize an adsorption-desorption equilibrium between the materials and SMX, and 1.0 mM of PS was added to activate the reaction; 1 mL of solution was taken at predetermined time intervals (2 min, 4 min, 6 min, 8 min, 10 min, 15 min, 20 min, 30 min and 60 min) and was filtered by the 0.45 μm filter membrane, and 0.1 mL of Na₂S₂O₄ (0.04 mM) quenching agent was added. The concentrations and TOC of SMX were detected by High Performance Liquid Chromatography (HPLC, Aglient 1260). Results were shown in FIG. 5. About 15% of SMZ was removed by MgMn-LDO-300, and nearly 97% of SMX was removed by CuO—MgMn-LDO-300, so that CuO—MgMn-LDO-300 showed more excellent catalytic performance. The degree of mineralization of CuO—MgMn-LDO-300 reaches 76% as well, which was far higher than that (5%) of MgMn-LDO-300.

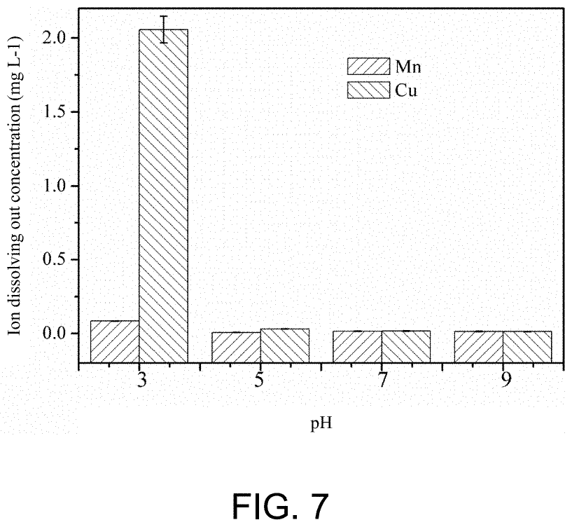

Test on influence of different Ph values in removal of sulfamethoxazole degraded by CuO—MgMn-LDO-300. The pH values of the sulfamethoxazole solutions were adjusted to different values (the pH values were set to be 3, 5, 7 and 9) with 0.1 M HNO3 and 0.1 M NaOH; and 4 parts of 50 mL of SMX (0.02 mM) were taken and numbered, and 10 mg of CuO—MgMn-LDO-300 was respectively added into the SMX. Magnetic stirring was performed for 30 min to realize an adsorption-desorption equilibrium between the materials and SMX, and 1.0 mM of PS was added to activate the reaction; 1 mL of solution was taken at predetermined time intervals (2 min, 4 min, 6 min, 8 min, 10 min, 15 min, 20 min, 30 min and 60 min) and was filtered by the 0.45 μm filter membrane, and 0.1 mL of Na₂S₂O₄ (0.04 mM) quenching agent was added. The concentrations of SMX were detected by High Performance Liquid Chromatography (HPLC, Aglient 1260). Related results of degradation of SMX by using CuO—MgMn-LDO-300 at different pH values were as shown in FIG. 6. In a pH range of 3-9, the removal efficiency of SMX could reach 88.8% or above within 30 min. At the same time, concentrations of Cu and Mn dissolved out in the solution were measured by the atomic absorption spectrophotometer, and a test result was shown in FIG. 7. Cu was dissolved out apparently when the pH value was greater than 3. The concentration of the released Cu met a drinking water standard (1.0 mg L⁻¹). When the pH value was greater than 5, the solubility of Mn was smaller than 0.1 mg L⁻¹. The research result verified the safety of removal SMX by using CuO—MgMn-LDO-300, proving the feasibility of Cu—MgMn-LDH reutilization.

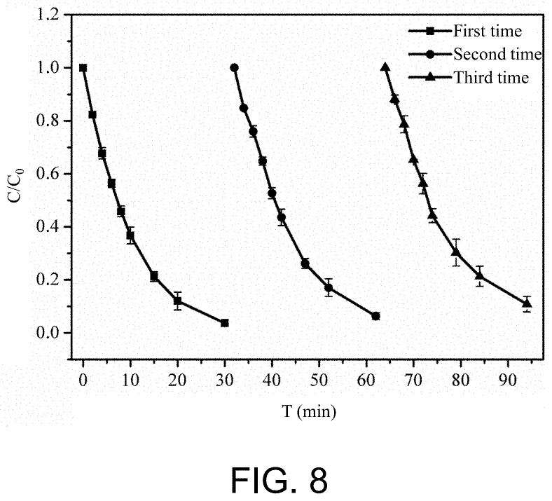

Test of recycling performance showing that CuO—MgMn-LDO-300 activates PMS to degrade sulfamethoxazole. Four parts of 1000 mL SMX (0.02 mM) were taken, 200 mg of CuO—MgMn-LDO-300 was added, magnetic stirring was performed for 30 min to realize an adsorption-desorption equilibrium between the materials and SMX, and 1.0 mM of PS was added to activate the reaction; 1 mL of solution was taken at predetermined time intervals (2 min, 4 min, 6 min, 8 min, 10 min, 15 min, 20 min, 30 min and 60 min) and was filtered by the 0.45 μm filter membrane, and 0.1 mL of Na₂S₂O₄ (0.04 mM) quenching agent was added. The concentrations of SMX were detected by High Performance Liquid Chromatography (HPLC, Aglient 1260). CuO—MgMn-LDO-300 was recovered for the next round of repeated experiment. The above steps were repeated for three times. The recycling performance of degrading sulfamethoxazole by CuO—MgMn-LDO-300 was shown in FIG. 8. It could be known from FIG. 8 that the effect of CuO—MgMn-LDO-300 that activates PS to degrade sulfamethoxazole was slightly decreased from 97% to 91% after being recycled for many times, showing that recycling performance of activating PMS to degrade sulfamethoxazole by CuO—MgMn-LDO-300 was strong, and further verifying the feasibility of Cu—MgMn-LDH reutilization.

The embodiments are preferred implementation modes of the present invention. The implementation modes of the present invention are not limited by the embodiments. Any other changes, modifications and substitutions made without departing from the spirit and principle of the present invention shall come within the protection scope of the present invention.

What is claimed is:

1. A method for preparing a layered magnesium manganese composite material for copper ion adsorption, comprising the following steps:
(1) dissolving a soluble magnesium salt and a soluble manganese salt in water to obtain a compound solution of the magnesium salt and the manganese salt;
(2) dissolving a soluble carbonate and a soluble hydroxide in water to obtain a compound solution of the carbonate and the hydroxide;
(3) dropwise adding the compound solution of the magnesium salt and the manganese salt obtained in step (1) into the compound solution of the carbonate and the hydroxide obtained in step (2), performing even stirring to obtain a mixed solution, allowing the mixed solution to age, centrifugalizing the mixed solution to take a precipitate, and subjecting the precipitate to washing, drying, grinding and sieving to obtain the layered magnesium manganese composite material for copper ion adsorption.

2. The method for preparing the layered magnesium manganese composite material for copper ion adsorption according to claim 1, wherein the magnesium salt in step (1) is magnesium chloride, magnesium nitrate or magnesium sulfate; the manganese salt in step (1) is manganese chloride, manganese nitrate or manganese sulfate; and in the compound solution of the magnesium salt and the manganese salt obtained in step (1), a concentration of the magnesium salt is 0.03-0.09 mol/L and a concentration of the manganese salt is 0.015-0.045 mol/L.

3. The method for preparing the layered magnesium manganese composite material for copper ion adsorption according to claim 1, wherein the carbonate in step (2) is sodium carbonate or potassium carbonate; the hydroxide in step (2) is sodium hydroxide or potassium hydroxide; and in the compound solution of the carbonate and the hydroxide obtained in step (2), a concentration of the carbonate is 0.0025-0.2 mol/L and a concentration of the hydroxide is 0.005-0.4 mol/L.

4. The method for preparing the layered magnesium manganese composite material for copper ion adsorption according to claim 1, wherein in the mixed solution obtained in step (3), a molar ratio of the magnesium salt to the manganese salt to the carbonate to the hydroxide is (5-60):(2.5-30):(1-15):(2-30).

5. The method for preparing the layered magnesium manganese composite material for copper ion adsorption according to claim 1, wherein in step (3), a rate of dropwise adding the compound solution of the magnesium salt and the manganese salt into the compound solution of the carbonate and the hydroxide is 0.1-5 mL/min, and a stirring time is 0.5-4 h.

6. The method for preparing the layered magnesium manganese composite material for copper ion adsorption according to claim 1, wherein an aging time in step (3) is 12-36 h, a drying mode comprises freeze drying with a drying time of 12-36 h, and a slot size for sieving is 100-500 meshes.

7. A layered magnesium manganese composite material for copper ion adsorption prepared by the method according to claim 1.

8. An application of the layered magnesium manganese composite material for copper ion adsorption according to claim 7 in catalyzing degradation of an antibiotic, comprising the following steps:
adsorbing copper ions by the layered magnesium manganese composite material for copper ion adsorption to obtain an adsorbed layered magnesium manganese composite material; heating the adsorbed layered magnesium manganese composite material for calcining treatment; cooling the adsorbed layered magnesium manganese composite material to room temperature to obtain CuO—MgMn-LDO; and adding the CuO—MgMn-LDO into an antibiotic solution to catalyze degradation of the antibiotic.

9. The application of the layered magnesium manganese composite material for copper ion adsorption in catalyzing degradation of the antibiotic according to claim 8, wherein a temperature of calcining treatment is 250-350° C., and a time of calcining treatment is 1-5 h.

10. The application of the layered magnesium manganese composite material for copper ion adsorption in catalyzing degradation of the antibiotic according to claim 8, wherein a pH value of the antibiotic solution is 3.0-9.0.
